(19) United States
(12) Patent Application Publication
(10) Pub. No.: US 2014/0226444 A1
(43) Pub. Date: Aug. 14, 2014

(54) Emergency Preparation and Survival All-In-One NOAA Radio Watch

(71) Applicant: Victoria Judith Otazo, Saugus, CA (US)

(72) Inventor: Victoria Judith Otazo, Saugus, CA (US)

(21) Appl. No.: 13/764,758

(22) Filed: Feb. 11, 2013

(51) Int. Cl. G04G 21/02

(52) U.S. Cl. CPC G04G 21/02
USPC 368/11

(57) ABSTRACT

This utility invention is an Emergency Preparation and Survival All-In-One NOAA Radio Watch . . . is disclosed.

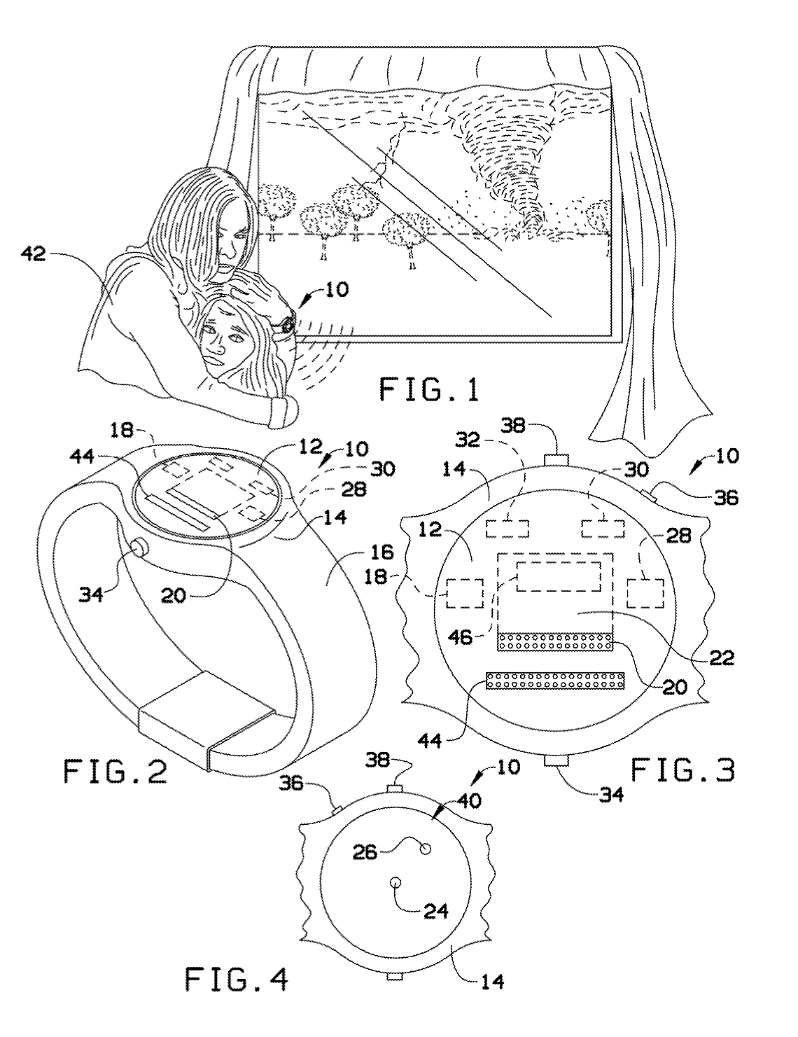

### BACKGROUND OF THE INVENTION

### Problem Solved

The watch is meant to be a utility for preparation for a catastrophe or to be used during a catastrophe, during an act of God, and a survival tool. Any of those persons who may be affected by such things should consider using this watch especially if one is prone to be affected by an earthquake, is stranded, is living in a danger zone and things of such a nature. Even boy and girl scouts would find this useful. A miniature version is more convenient because it frees up the hands and allows the person to multi-task or attend to a greater need while being guided by a weather report per say or when following their route out of the wilderness for instance. If a family is under the attic during a tornado and she has children, she can hear the reports on how to be safe as she takes care of her children without having to be near the larger portable radio.

Claims aforementioned.

### DETAILED DESCRIPTION OF THE INVENTION

As stated above, The watch is meant to be a utility for preparation for a catastrophe or to be used during a catastrophe, during an act of God, and a survival tool. Any of those persons who may be affected by such things should consider using this watch especially if one is prone to be affected by an earthquake, is stranded, is living in a danger zone and things of such a nature. Even boy and girl scouts would find this useful. A miniature version is more convenient because it frees up the hands and allows the person to multi-task or attend to a greater need while being guided by a weather report per say or when following their route out of the wilderness for instance. If a family is under the attic during a tornado and she has children, she can hear the reports on how to be safe as she takes care of her children without having to be near the larger portable radio. The invention claimed here solves this problem.

The features included therein are a miniaturized version of a regular NOAA Radio that will receive signal from the NOAA broadcasts in case of an emergency. The other features include the time in digits, the date, elevation in feet and miles in parenthesis, a waterproof watch, a GPS system with on or off switch for voice, and compass.

### The Version of the Invention Discussed Here Includes

1. NOAA Radio signal waterproof speaker with on and off switch
2. Time in digits
3. The date in digits
4. Elevation of feet in digits
5. Miles in parenthesis
6. GPS tracking system with directions
7. Voice on and off switch button
8. Compass
9. Waterproof watch
10. LCD screen on watch
11. Main switch for components on display

### Relationship Between the Components

Step 10 should be the centerpiece where all components are on display for the user. For all other steps are related to Step 10 because they appear upon the Step 10 or the LCD screen.

Step 5 and Step 7 are not on the main screen for sake of space. They are respectively miles and voice option for prompting the GPS voice on and off button in case for the disabled. The GPS directions is on display or for voice. For instance if we click the button to play the GPS directions such as turn right in 350 feet then it will read it to you likewise you may opt for reading it “Turn right in 350 feet”

Step 9 is built within, it is a waterproof watch likewise it relates to Step 1 because the speaker through which signal is broadcasted is also waterproof

Steps 1, 2, 3, 4, 6, and 8 are on the front screen of the LCD screen at all times. Now with Step 10 they may be called upon by clicking of a side button on the watch to change the component or function to be enlarged and at the center. For instance, if we want to see the date we would click the side of the watch till it read the date in large digital print and even look forward to and from the day upon the screen.

### How the Invention Works

This is to be as user efficient and friendly as possible. For making the display LCD waterproof, NOAA watch turned on by a switch and waterproof, and digital it is easier to read and navigate than most watches. And even performs better than carrying a radio around which is difficult to understand since there are many radios. The main component switch toggles by the click of the button on the side to each other step therefore making it easy for the user to focus on his or her needs. The most important functions are on the LCD screen when switched on.

### How to Make the Invention

This person would need knowledge in building small electronic devices that could withstand extreme temperatures such as rain, hail, cold, snow, or water. This person may have to know how to make the device using knowledge of how to build in LCD screens on a durable and sturdy watch. They would also have to know how to keep the leather or strip sturdy as well; the whole watch must be sturdy to withstand anything. LCD screens should not be easily breakable. This person should know the signal flow between towers and watches as well as incorporating digits on a screen. And understanding navigation systems as well as speakers that could resist water or extreme temperature.

Elements which are necessary are signal, date, time, LCD screen and digits on display and GPS tracking system. Which is optional are the compass, elevation in feet, miles, and the voice on and off switch.

The compass could be read on the GPS screen or directions screen and the voice could be read through the GPS system.

### How to Use the Invention

Again in case of an emergency the person need only strap on the watch on him/herself and family members and pay attention to the NOAA radio's warnings over any disaster or act of God. For instance, if a fisherman is stranded his comrades can track him using the GPS device that he would have carried on his wrist. In case of a tornado warning, the mother or father of a family could be freed up from being close to the radio and be portable with the information needed to escape out of harm's way. The GPS system could help a lost boy scout or girl scout in the woods return safely to the campground. There are countless examples. Specifically the person need turn on the watch, watch for signals from NOAA, change the component by main component switch or read main screen and just follow directions on watch tech script for any further instructions on how to use the watch for their own purpose and need at the time.

Additionally: Perhaps for military men and women and NASA men and women and anyone in the field of archeology or anyone expose to the elements of nature could greatly benefit from a protective device such as this.

Also, it can create: A packet or book on how to protect oneself from the elements in wait for survival.

1. It features a miniaturized version of NOAA radio on a watch conveniently placed on your wrist where you are mobile to receive incoming weather reports and warnings

2. In addition to featuring number 1, with it comes a GPS tracker that has a feature that allows you either hear the directions of a route via electronic voice or to read the directions on an LCD screen as simple as “turn left” etc.

3. It is the only waterproof weather report watch
